(19) United States
(12) Patent Application Publication
(10) Pub. No.: US 2024/0390927 A1
(43) Pub. Date: Nov. 28, 2024

(54) COATING APPARATUS

(71) Applicant: Taikisha Ltd., Tokyo (JP)

(72) Inventors: Kenji SAKITA, Ebina-shi (JP); Hiroshi IWAKIRI, Yamato-shi (JP); Shogo NODA, Ebina-shi (JP)

(21) Appl. No.: 18/603,006

(22) Filed: Mar. 12, 2024

(30) Foreign Application Priority Data
May 23, 2023 (JP) 2023-084679

(51) Int. Cl. B05B 16/60; B05B 16/40

(52) U.S. Cl. CPC B05B 16/60; B05B 16/40

(57) ABSTRACT

A coating apparatus comprising: a coating chamber in which a coating is applied to an object to be coated which is transported in a transport direction; and a gas supply duct that is provided in a central area of a ceiling surface of the coating chamber in a width direction that intersects the transport direction and extends in the transport direction, wherein the gas supply duct includes a semi-cylindrical outlet that protrudes from the ceiling surface into the coating chamber and blows gas into the coating chamber in radial directions in an intersecting plane that intersects the transport direction.

### CROSS-REFERENCE TO RELATED APPLICATION(S)

This application claims priority to and the benefit of Japanese Patent Application No. 2023-084679 filed on May 23, 2023, the entire disclosure of which is incorporated herein by reference.

### BACKGROUND OF THE INVENTION

### Field of the Invention

The present invention relates to a coating apparatus.

### Description of the Related Art

Conventionally, coating booths for applying a coating to objects to be coated such as vehicle bodies are known. Japanese Utility Model Laid-Open No. 49-112857 discloses a coating booth in which gas is supplied from the ceiling surface of a coating chamber 1 and is discharged from exhaust vents 3 located at the bottom of the coating chamber 1.

### SUMMARY OF THE INVENTION

However, according to the technology described in Japanese Utility Model Laid-Open No. 49-112857, the gas supply surface provided in a central area of the ceiling surface of the coating booth is flat, and therefore, it is difficult to supply gas to the entire coating chamber, and there is a problem in that the wall surfaces may become dirty or gas flow vortices may occur and cause discoloration.

The present invention has been made in view of the above problem, and an object of the present invention is to provide a technique for realizing a stable gas flow within a coating chamber.

According to one aspect of the present invention, there is provided a coating apparatus comprising: a coating chamber in which a coating is applied to an object to be coated which is transported in a transport direction; and a gas supply duct that is provided in a central area of a ceiling surface of the coating chamber in a width direction that intersects the transport direction and extends in the transport direction, wherein the gas supply duct includes a semi-cylindrical outlet that protrudes from the ceiling surface into the coating chamber and blows gas into the coating chamber in radial directions in an intersecting plane that intersects the transport direction.

### BRIEF DESCRIPTION OF THE DRAWINGS

FIG. 1 is a front view showing a configuration example of a coating apparatus according to an embodiment.

FIG. 2 is an external view showing a configuration example of a coating apparatus according to an embodiment.

FIG. 3 is an illustration of a gas flow distribution of gas supplied from a gas supply duct according to an embodiment.

FIG. 4 is an illustration of a gas flow distribution when a gas supply duct according to an embodiment is provided with a guide plate.

FIG. 5 is a diagram showing a configuration example of a corner section of a coating chamber according to an embodiment.

FIG. 6 is a diagram showing an example of a flow velocity or flow rate varying for each radial direction of a gas supply duct according to an embodiment.

FIG. 7 is a cross-sectional view of a structure of a gas supply duct according to an embodiment.

FIG. 8 is an external view of an outer frame of a gas supply duct according to an embodiment.

FIG. 9 is an external view of an outer frame of a gas supply duct and an adjustment plate according to an embodiment.

### DESCRIPTION OF THE EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

### <Configuration of Coating Apparatus>

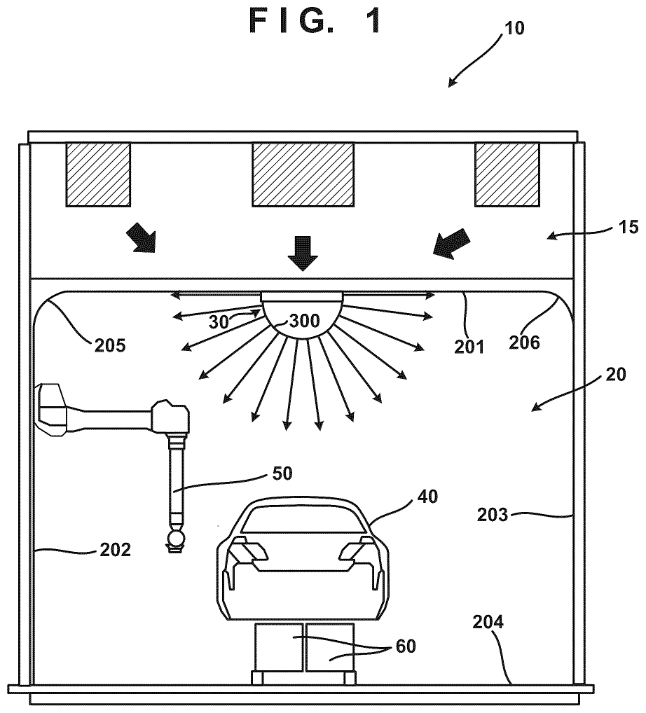

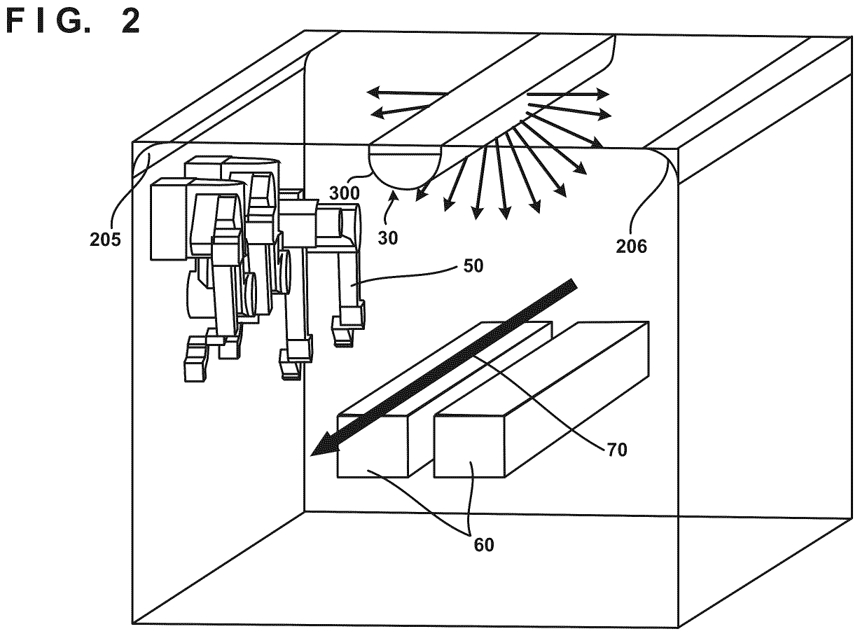

FIG. 1 is a front view of a coating apparatus according to an embodiment. FIG. 2 is an external view of a coating apparatus according to an embodiment. A coating apparatus 10 includes a coating chamber 20 in which a coating is applied to an object 40 to be coated. Although the object to be coated in the present embodiment is a vehicle body, the present embodiment is applicable to other objects. The coating chamber 20 is formed so as to be surrounded by a ceiling surface 201, a side wall surface 202, a side wall surface 203, and a bottom surface 204. Coating spray devices 50 perform spray coating on the object 40 placed on a mounting table 60 and transported in a transport direction 70 into the coating chamber 20. The coating spray devices 50 are provided symmetrically within the coating chamber 20, one of which (not shown) is provided on the side wall surface 203. The coating apparatus 10 includes a gas supply duct 30 provided in a central area of the ceiling surface 201 of the coating chamber 20. Gas (for example, air) is supplied from a gas supply space 15 provided above the coating chamber 20 to the gas supply duct 30, and the gas is blown through the surface of the gas supply duct 30 into the coating chamber 20. The gas supply duct 30 extends in the transport direction 70 in which the object 40 is to be transported, and protrudes from the ceiling surface 201 into the coating chamber 20. The gas supply duct 30 includes a semi-cylindrical outlet 300 that blows gas into the coating chamber 20 in radial directions in an intersecting plane that intersects the transport direction 70.

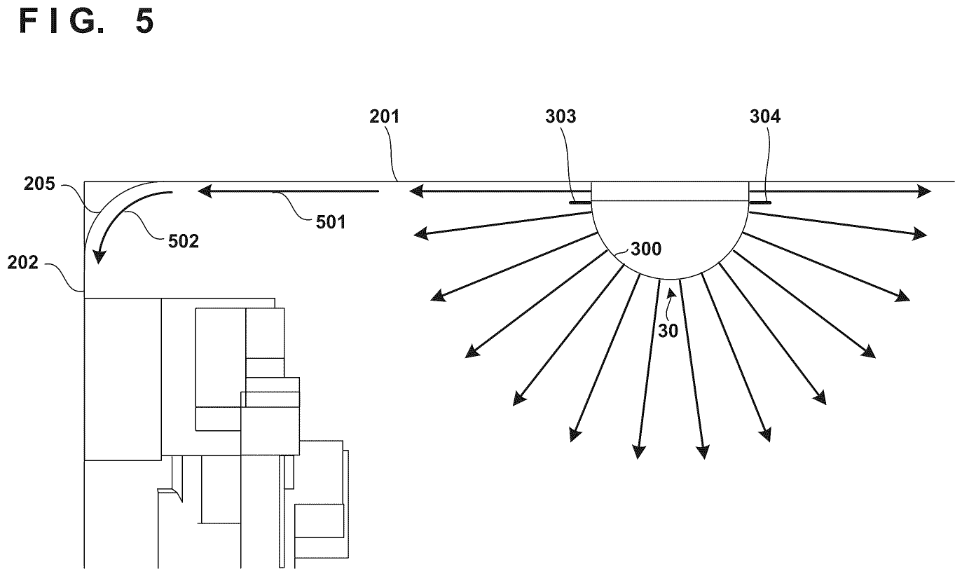

The coating chamber 20 may be provided with a corner guide portion 205 at a corner section formed by the ceiling surface 201 and the side wall surface 202. Here, FIG. 5 is a diagram showing a configuration example of the corner section of the coating chamber. As shown in FIG. 5, due to the corner guide portion 205 thus formed, the gas moving in a horizontal direction as indicated by an arrow 501 along the ceiling surface 201 can be curved as indicated by an arrow 502 and smoothly guided in the direction along the side wall surface 202. The corner guide portion 205 has a curved surface with a predetermined curvature. The ceiling surface 201 and the side wall surface 202 are smoothly connected to each other via the curved surface. For example, the curved surface can be a quadrant cylindrical surface and can be in the range of 400R to 800R (a radius of 400 mm to a radius of 800 mm). Similarly, a corner guide portion 206 may be provided in the coating chamber 20 at a corner section formed by the ceiling surface 201 and the side wall surface 203 to guide the gas moving in a horizontal direction along the ceiling surface 201, along the side wall surface 203.

### <Gas Flow Distribution>

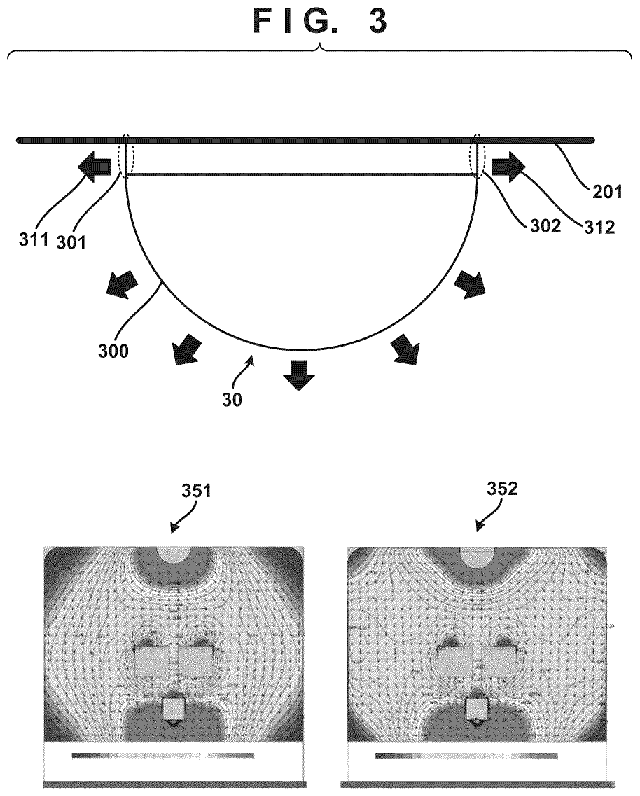

Next, the gas flow distribution of gas supplied from a gas supply duct according to an embodiment will be described with reference to FIG. 3. The gas supply duct 30 includes a horizontal outlet port 301 and a horizontal outlet port 302 that guide a portion of the gas supplied from the gas supply duct 30 into the coating chamber 20, in a horizontal direction. The horizontal outlet port 301 guides a portion of the gas supplied from the gas supply duct 30 into the coating chamber 20, in a horizontal direction toward the side wall surface 202. Gas is blown from the horizontal outlet port 301 in the horizontal direction indicated by an arrow 311. The horizontal outlet port 302 guides a portion of the gas supplied from the gas supply duct 30 into the coating chamber 20, in a horizontal direction toward the side wall surface 203. Gas is blown from the horizontal outlet port 302 in the horizontal direction indicated by an arrow 312.

The semi-cylindrical outlet 300 has a semi-cylindrical shape whose diameter is a straight line connecting the lower end of the horizontal outlet port 301 and the lower end of the horizontal outlet port 302. Note that it is not always necessary to provide horizontal outlet port 301 and the horizontal outlet port 302. When the horizontal outlet port 301 and the horizontal outlet port 302 are not provided, the semi-cylindrical outlet 300 may be configured to protrude directly from the ceiling surface 201. That is to say, the semi-cylindrical outlet 300 may be configured such that the diameter thereof is located at the same height as the ceiling surface 201.

Here, a gas flow distribution 351 shows the gas flow distribution when the diameter of the semi-cylinder is on the ceiling surface 201 and the horizontal outlet port 301 and the horizontal outlet port 302 are not provided. On the other hand, a gas flow distribution 352 shows the gas flow distribution when the horizontal outlet port 301 and the horizontal outlet port 302 are provided and the diameter of the semi-cylinder is located below the ceiling surface 201. In the gas flow distribution 352 compared to the gas flow distribution 351, the gas flow is more diffused in the horizontal direction near the ceiling surface 201, and the gas flow condition is better near the side wall surfaces. As a result, it can be seen that stable gas flows are formed in the entire coating chamber 20. Therefore, it is possible to prevent the wall surfaces from becoming dirty and prevent gas flow vortices from being generated and causing discoloration.

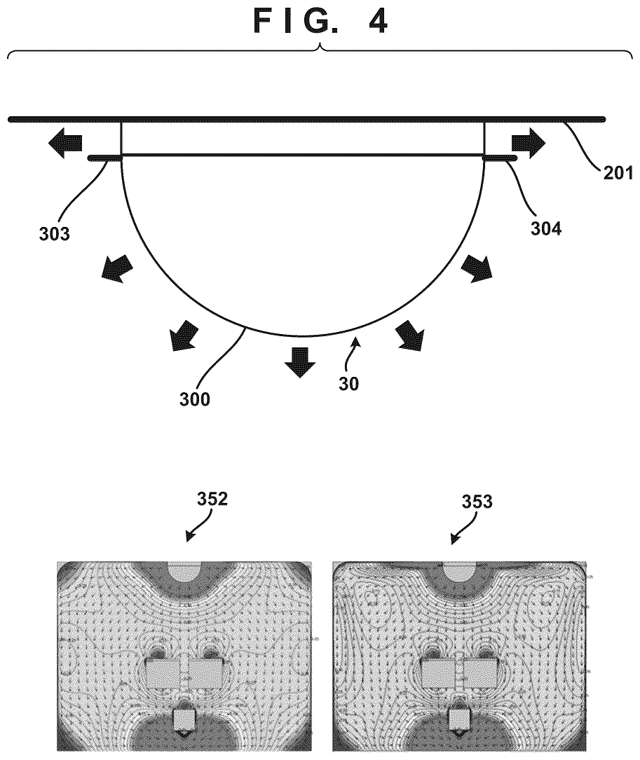

Next, the gas flow distribution when a gas supply duct according to an embodiment is provided with a guide plate will be described with reference to FIG. 4. The gas supply duct 30 may further be provided with a guide plate 303 and a guide plate 304 each extending in a horizontal direction. The guide plate 303 is provided between the horizontal outlet port 301 and the semi-cylindrical outlet 300 and extends in a horizontal direction toward the side wall surface 202. The guide plate 304 is provided between the horizontal outlet port 302 and the semi-cylindrical outlet 300 and extends in a horizontal direction toward the side wall surface 203. The horizontal outlet port 301 and the horizontal outlet port 302 are respectively provided between the ceiling surface 201 and the guide plate 303 and between the ceiling surface 201 and the guide plate 304. The guide plate 303 and the guide plate 304 may be rectangular flat plate members. The guide plate 303 and the guide plate 304 each protrude in a horizontal direction from a portion of the surface of the semi-cylindrical gas supply duct 30. For example, each may be a flat plate member that protrudes approximately 100 mm in a horizontal direction.

Here, the gas flow distribution 352 is the same as the gas flow distribution shown in FIG. 3, and is the gas flow distribution when the horizontal outlet port 301 and the horizontal outlet port 302 are provided, but the guide plate 303 and the guide plate 304 are not provided. On the other hand, a gas flow distribution 353 is the gas flow distribution when the horizontal outlet port 301 and the horizontal outlet port 302 are provided and the guide plate 303 and the guide plate 304 are also provided. In the gas flow distribution 353 compared to the gas flow distribution 352, the gas flow is further diffused in the horizontal direction near the ceiling surface 201, and the gas flow condition is even better near the side wall surfaces. As a result, it can be seen that more stable gas flows are formed in the entire coating chamber 20. Therefore, it is possible to prevent the wall surfaces from becoming dirty and prevent gas flow vortices from being generated and causing discoloration.

### <Adjustment of Flow Velocity or Flow Rate for Each Radial Direction>

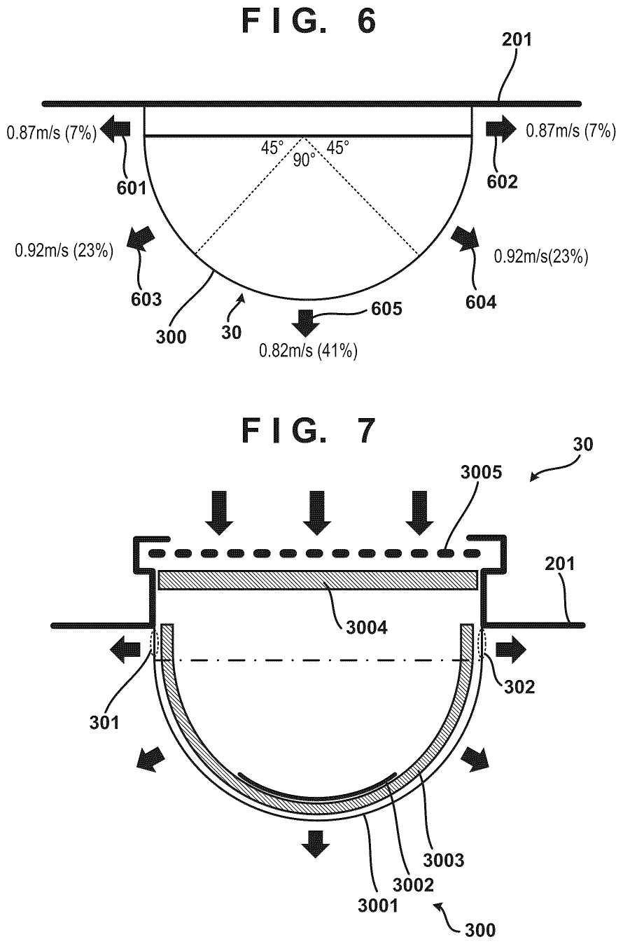

Next, FIG. 6 is a diagram showing an example of a flow velocity or flow rate varying for each radial direction of a gas supply duct according to an embodiment. It is possible to employ a configuration in which the flow velocity and/or flow rate of the gas supplied from the gas supply duct 30 into the coating chamber 20 varies for each radial direction. In FIG. 6, the configuration is such that the flow velocity is 0.87 m/s (the flow rate is approximately 7%) in the directions indicated by arrows 601 and 602 (horizontal directions). The configuration is such that the flow velocity is 0.92 m/s (the flow rate is approximately 23%) in the directions indicated by arrows 603 and 604 (the angle range of 45 degrees in the diagonal directions). The configuration is such that the flow velocity is 0.82 m/s (the flow rate is approximately 41%) in the direction indicated by an arrow 605 (the angle range of 90 degrees including the vertical downward direction).

It is possible to employ a configuration in which the longer the length of the ceiling surface 201 of the coating chamber 20 in the width direction thereof (the direction intersecting the transport direction) (i.e., the longer the distance between the side wall surface 202 and the side wall surface 203), the higher the wind speed of the gas supplied in the horizontal direction. It is also possible to employ a configuration in which the longer the ceiling surface 201 of the coating chamber 20 in the width direction thereof, the higher the flow rate of the gas supplied in the horizontal direction. As a result, it is possible to stably diffuse the gas flow in the entire coating chamber according to the size of the coating chamber in the width direction thereof.

It is also possible to employ a configuration in which the higher the height of the ceiling surface 201 of the coating chamber 20 (i.e., the longer the distance between the ceiling surface 201 and the bottom surface 204), the higher the flow velocity of the gas supplied vertically downward. It is also possible to employ a configuration in which the higher the ceiling surface 201 of the coating chamber 20, the higher the flow rate of the gas supplied vertically downward. As a result, it is possible to stably diffuse the gas flow in the entire coating chamber according to the size of the coating chamber in the height direction thereof.

### <Structure of Gas Supply Duct and Method for Adjusting Flow Velocity or Flow Rate>

Next, the structure of a gas supply duct and a method for adjusting a flow velocity or flow rate according to an embodiment will be described with reference to FIGS. 7 to 9.

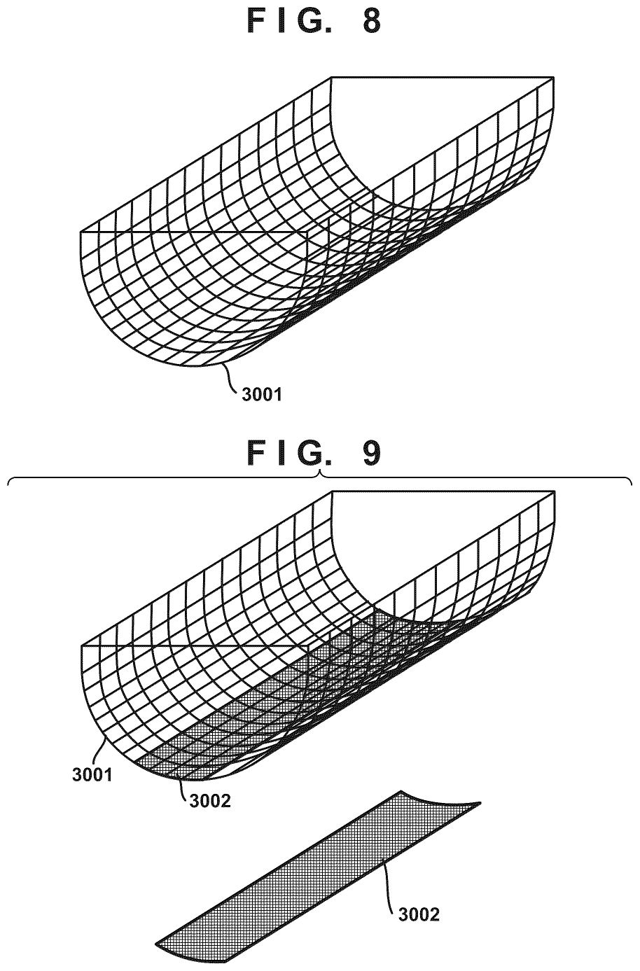

FIG. 7 is a cross-sectional view of a structure of the gas supply duct 30 according to an embodiment. The gas supply duct 30 includes an outer frame 3001, and an adjustment plate 3002, a filter 3003, a filter 3004, and an adjustment plate 3005. Here, the semi-cylindrical outlet 300 includes the outer frame 3001, the adjustment plate 3002, and the filter 3003. The filter 3003 further extends from the outer frame 3001 to the horizontal outlet port 301 and the horizontal outlet port 302. FIG. 8 is an external view of the outer frame 3001 according to an embodiment. The outer frame 3001 has a semi-cylindrical structure with metal rods stretched in a grid pattern. Gas is blown through the grid into the coating chamber 20.

FIG. 9 is an external view of the outer frame 3001 and the adjustment plate 3002 according to an embodiment. The adjustment plate 3002 has a shape formed by making grid-shaped (or circular) punch holes in a metal plate at predetermined intervals and shaping the metal plate into a curved shape extending along a portion of a cylinder. Gas can pass through the locations of the punched holes, but cannot pass through the locations of the other metal portions. Therefore, by arranging the adjustment plate 3002 with punch holes that vary in size and/or number at any positions of the semi-cylinder, it is possible to adjust the flow velocity and/or flow rate of the gas blown into the coating chamber 20 from the location where the adjustment plate 3002 is arranged. For example, in FIG. 6, by placing the adjustment plate 3002 in the angle range of 90 degrees including the vertical downward direction, it is possible to reduce and adjust the flow velocity within this angle range to 0.82 m/s, or to adjust the flow volume within this angle range to approximately 41% of the total.

In addition, the filter 3003 is provided between the outer frame 3001 and the adjustment plate 3002. The filter 3003 is a semi-cylindrical filter. By providing the filter 3003, it is possible to prevent impurities such as dust from entering the coating chamber 20. The filter 3004 is another filter. The filter 3004 is a primary filter that adsorbs impurities such as dust contained in the gas supplied from the gas supply space 15 provided above the coating chamber 20 to the gas supply duct 30. When the filter 3004 is provided, the filter 3003 functions as a secondary filter. The adjustment plate 3005 is an adjustment plate for adjusting the flow velocity or flow rate of gas supplied from the gas supply space 15 to the gas supply duct 30. The adjustment plate 3005 may have the same configuration as the adjustment plate 3002.

As described above, by placing one gas supply duct extending along the transport direction of the object in a central area of the ceiling of the coating chamber, it is possible to prevent the coating spray devices 50, which is a robot extending from the side walls, and the gas supply duct 30 from interfering with each other. In a configuration in which a plurality of gas supply ducts are arranged on the ceiling surface, the operable ranges of the coating spray devices 50 are limited in order to prevent the coating spray devices 50 and the gas supply ducts 30 from coming into contact with each other. However, the configuration of the present embodiment is free from such limitation.

With a configuration in which the gas supply duct that has a semi-cylindrical shape protruding from the ceiling surface into the coating chamber is capable of blowing gas from the semi-cylindrical surface into the coating chamber in radial directions as in the present embodiment, it is possible to form a stable gas flow in the entire coating chamber 20. Therefore, it is possible to prevent the wall surfaces from becoming dirty and prevent gas flow vortices from being generated and causing discoloration.

The invention is not limited to the foregoing embodiments, and various variations/changes are possible within the spirit of the invention.

What is claimed is:

1. A coating apparatus comprising:
a coating chamber in which a coating is applied to an object to be coated which is transported in a transport direction; and
a gas supply duct that is provided in a central area of a ceiling surface of the coating chamber in a width direction that intersects the transport direction and extends in the transport direction,
wherein the gas supply duct includes a semi-cylindrical outlet that protrudes from the ceiling surface into the coating chamber and blows gas into the coating chamber in radial directions in an intersecting plane that intersects the transport direction.

2. The coating apparatus according to claim 1,
wherein the gas supply duct further includes a horizontal outlet port that blows gas in a horizontal direction in the intersecting plane.

3. The coating apparatus according to claim 2,
wherein the gas supply duct further includes a guide plate that is provided between the semi-cylindrical outlet and the horizontal outlet port and extends in a horizontal direction.

4. The coating apparatus according to claim 3,
wherein the guide plate protrudes in a horizontal direction from a surface of the gas supply duct.

5. The coating apparatus according to claim 1,
wherein the coating chamber includes the ceiling surface, a first side wall surface, and a second side wall surface that faces the first side wall surface, and
the gas supply duct includes:
a first horizontal outlet port that guides a portion of gas supplied from the gas supply duct, in a horizontal direction toward the first side wall surface; and
a second horizontal outlet port that guides a portion of gas supplied from the gas supply duct, in a horizontal direction toward the second side wall surface.

6. The coating apparatus according to claim 5,
wherein the semi-cylindrical outlet has a semi-cylindrical shape whose diameter is a straight line connecting a lower end of the first horizontal outlet port and a lower end of the second horizontal outlet port.

7. The coating apparatus according to claim 1,
wherein the coating chamber includes the ceiling surface and a side wall surface, and
a corner guide portion that guides gas that moves in a horizontal direction along the ceiling surface, along the side wall surface, is provided at a corner section formed by the ceiling surface and the side wall surface.

8. The coating apparatus according to claim 7,
wherein the corner guide portion has a curved surface with a predetermined curvature, and
the ceiling surface and the side wall surface are connected to each other via the curved surface.

9. The coating apparatus according to claim 1,
wherein a flow velocity of gas that is blown from the gas supply duct varies for each radial direction.

10. The coating apparatus according to claim 1,
wherein the gas supply duct includes:
a semi-cylindrical outer frame;
an adjustment plate that is provided with a plurality of openings; and
a semi-cylindrical filter that is provided between the outer frame and the adjustment plate.
